(19) United States
(12) Patent Application Publication
(10) Pub. No.: US 2017/0015053 A1
(43) Pub. Date: Jan. 19, 2017

(54) BONDING DEVICE OF DOOR TRIM FOR VEHICLE

(71) Applicant: GUNYANG ITT CO., LTD., Busan (KR)

(72) Inventor: Teak-Hyun KIM, Busan (KR)

(21) Appl. No.: 15/121,198

(22) PCT Filed: Jul. 8, 2015
(86) PCT No.: PCT/KR2015/007098

§ 371 Date: Aug. 24, 2016

(30) Foreign Application Priority Data
Jul. 11, 2014 (KR) 10-2014-0087632

(51) Int. Cl. B29C 65/60; B29C 65/00; B29C 65/04

(52) U.S. Cl. CPC B29C 65/607; B29C 65/04; B29C 66/05; B29K 2701/12

(57) ABSTRACT

The objective of the present invention is to provide a vehicle door trim bonding device capable of quickly bonding sub-trims. In order to achieve the objective, the present invention provides a vehicle door trim bonding device for coupling a first sub-trim in which a projection is formed and which is made of a thermoplastic resin material, and a second sub-trim in which a receiving hole for receiving the projection of the first sub-trim is formed and which is made of a thermoplastic resin material, the device comprising: a heat supply unit for melting a part of the protrusion with radiation heat; and a molding part for compression-molding the molten protrusion.

### CROSS-REFERENCE TO RELATED APPLICATION(S)

The present application is the United States national phase entry of PCT Application No. PCT/KR2015/007098, filed 8 Jul. 2015, which in turn derives priority from Korean Patent Application No. 10-2014-0087632, filed 11 Jul. 2014.

### BACKGROUND OF THE INVENTION

1. Field of the Invention

The present disclosure relates to a bonding device of a door trim for a vehicle, and more particularly to a bonding device of a door trim for a vehicle that is capable of performing faster work.

2. Description of the Background

Generally, a vehicle door includes a door panel formed of a steel plate and a door trim disposed inside of the vehicle by being attached to the door panel.

The door trim is composed of a plurality of sub trims connected to one another. The door trim is assembled by a process where each of the boundary parts of the sub trims is affixed to one another after each of the components is joined to the door panel. Up to the present time, various types of methods have been suggested for combining each of the sub trims.

For example, Korean Patent Publication No. 2004-0035052 discloses a bolt/nut type method comprising: forming a hitching protrusion integrally on an inner surface of a rear periphery of a door trim and concurrently forming a coupling hole on a lateral surface; forming a supporting hole at a door inner panel on a position corresponding to the hitching protrusion and inserting the hitching protrusion in the supporting hole; and coupling a screw in the coupling hole and pushing the hitching protrusion with the screw to couple the hitching protrusion in the supporting hole.

In addition, Korean Patent Publication No. 2004-0006608 discloses a grommet-typed method comprising: forming a quadrangular-shaped groove having a hitching sill integrally on both lateral surfaces and a lower edge part of a door trim forming a quadrangular-shaped coupling hole at a door inner panel on a position corresponding to the quadrangular-shaped groove; forming a grommet where a length and a width of the grommet is formed the same as those of the quadrangular-shaped groove, and concurrently forming a hitching groove on a lateral surface of the grommet, such that the hitching sill matches with a lateral surface of the quadrangular-shaped coupling hole; and inserting the hitching groove in the hitching sill and the quadrangular-shaped coupling hole to couple such that an upper surface of the grommet is on a same surface with the edge part of the door trim.

In addition, Korean Patent Publication No. 2002-0031796 discloses a clip-type structure of a vehicle door trim including a main panel and a sub panel coupled to the main panel, the vehicle door trim comprising: a long slide groove formed on both sides of an outer edge; a coupling boss so provided at the sub panel as to be inserted in a coupling hole formed on the main panel; and a wedge-shaped clip coupled to a long slide groove of the coupling boss.

The foregoing methods of combining sub trips use a separate coupling member. Therefore, those methods have an advantage in that the door trim can be disassembled, but also a disadvantage in that assembly of components becomes complex.

New techniques, wherein some parts of a sub trim formed of plastic are combined and melted to be permanently coupled, have been suggested in order to improve the conventional technique, and are currently in wide use.

In these melting-type methods, a protrusion is formed on one end of a sub trim and an accommodating groove is formed on another end of the sub trim such that the protrusion is coupled in the accommodating groove. Afterwards, the protruding parts are combined by being melted. The melting-type methods are advantageous in automation.

The permanent combination as described above must include a heat supplier applying heat on the protrusion and a molding, part molding the protrusion melted by the heat. At first, the heat supplier melts some part of the protrusion, and the molding part is pressurized on the melted part to finally assemble the sub trim.

The heat supplier may be categorized into a conduction type, where to heating part contacts and melts the protrusion, and a convection type, where the heating part supplies convection heat to melt the protrusion. The conduction type has a disadvantage of long heating times, and the convection type has a disadvantage in that heat wasted after heating by the convection heater causes environmental pollution and thermal losses. The conduction type has a particular disadvantage in that it is difficult to mold the protrusion by pressurization of the molding part when a separate supporting part is not provided on a rear surface of the sub trim. Therefore, a new coupling device not requiring any special supporting force is required.

### SUMMARY OF THE INVENTION

The present disclosure is contrived to solve the foregoing problem of the related art, and an object of the present disclosure is to provide a vehicle door trim coupling device that is capable of quickly coupling sub trims.

In order to achieve at least the above objects, in whole or in part, and in accordance with the purposes of the present disclosure, as embodied and broadly described, and in a general aspect, there is provided a vehicle door trim coupling device for combining a first sub trim made of a thermoplastic resin material formed with a protrusion and a second sub trim made of a thermoplastic resin material formed with an accommodating groove for accommodating the protrusion of the first sub trim, the vehicle door trim coupling device comprising: a heat supplier configured to melt a part of the protrusion by radiant beat; and a molding part configured to press-mold the melted protrusion.

In some exemplary embodiments, the heat supplier may include: a body; a heating hole formed at a lower end of the body and accommodating a part of the protrusion; and a heater formed spaced apart from a circumferential surface of the protrusion at a predetermined distance by being disposed inside of the heating hole, and configured to emit radiant heat.

In some exemplary embodiments, a temperature of the heater may be 200° C. ˜800° C.

In some exemplary embodiments, a temperature of the heater may be 500° C. ˜800° C.

In some exemplary embodiments, the heater may take a shape of a continuously curved flat plate.

In some exemplary embodiments, the molding part may include: a rod; and a contracting part attached on a distal end of the rod and configured to pressurize the melted protrusion.

In some exemplary embodiments, an air hole may be formed at the rod such that pneumatic air can be discharged through the air hole after molding is finished.

In some exemplary embodiments, an air hole may be formed at the contacting part such that pneumatic air can be discharged through the air hole after molding is finished.

In some exemplary embodiments, the body may further include, in an internal center thereof, a penetrating hole in a longitudinal direction, and the molding part may be disposed in the penetrating hole to move in a longitudinal, direction of the penetrating hole.

In some exemplary embodiments, after the protrusion is melted by the beat supplier, the molding part disposed in the penetrating hole may move downward to pressurize and mold the melted protrusion.

The vehicle door trim coupling device according to an exemplary embodiment of the present disclosure includes a heat supplier and a molding part. The heat supplier does not waste energy, because the heat supplier instantaneously radiates heat by momentarily supplying electric power only when heating. Here, the heat supplier instantaneously provides electric power only when heating to instantaneously radiate heat, such that energy may not be wasted. In addition, the heat supplier provides radiant heat to a lateral surface of the protrusion, such that molding can be performed immediately after melting is completed, thereby cooling time can be reduced and the sub trims can be combined as well without any additional supporting force. Furthermore, there is still another advantageous effect in that the coupling time of all sub trims can be shortened to enhance the entire assembly productivity through the foregoing structure of the vehicle door trim coupling device according to an exemplary embodiment of the present disclosure.

### BRIEF DESCRIPTION OF THE DRAWINGS

FIG. 1 is a sectional view illustrating a door trim structure coupled using a vehicle door trim coupling device according to an exemplary embodiment of the present disclosure.

FIG. 2 is a block diagram illustrating a vehicle door trim coupling device according to an exemplary embodiment of the present disclosure.

FIG. 3 illustrates a shape view illustrating the heat supplier illustrated in. FIG. 2.

FIG. 4 is an entire block diagram for implementing the device of FIG. 2.

FIG. 5 is a view illustrating another exemplary embodiment of FIG. 4.

FIG. 6 is an operational state view of FIG. 5.

### DETAILED DESCRIPTION OF THE PREFERRED EMBODIMENTS

Hereinafter, an exemplary embodiment of the present disclosure will be described in detail with reference to the accompanying drawings. The following reference characters will be used herein in referring to the listed components:

| | |
|---|---|
| 10: first sub trim | 11: protrusion |
| 20: second sub trim | 21: accommodating hole |
| 30: heat supplier | 31: body |
| 32: heater | 33: heating hole |
| 39: penetrating hole | 50: molding part |
| 51: rod | 52: contacting part |
| 54: air hole | 60: driving device |
| 61: rotating base | 62: heating actuator |
| 63: molding actuator | |

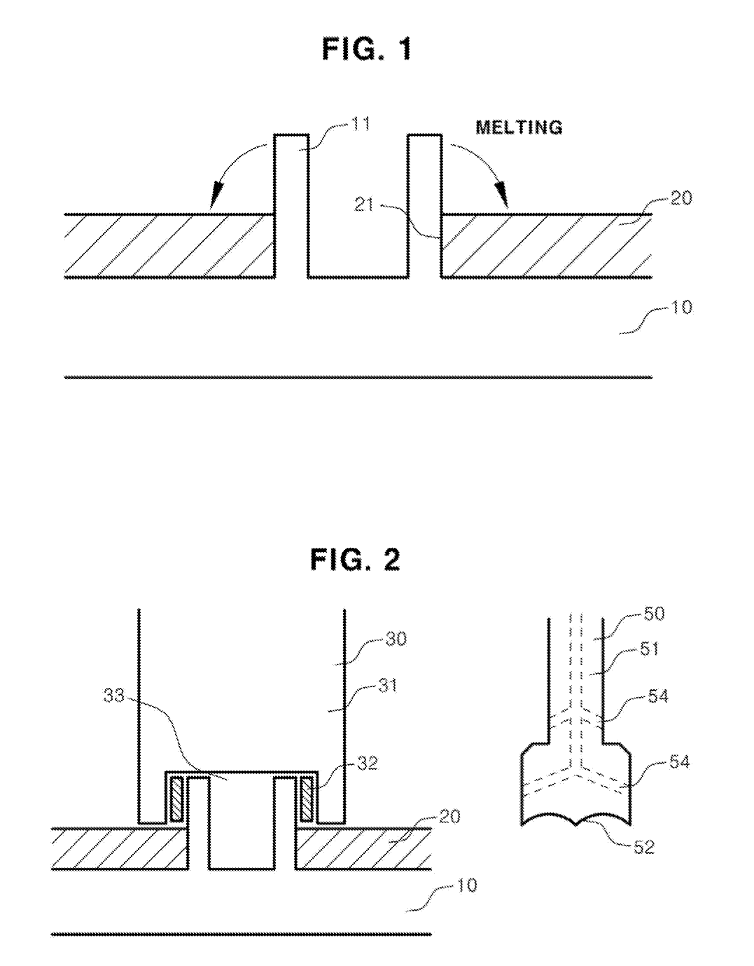

As illustrated in FIG. 1, the vehicle door trim coupling device according to an exemplary embodiment of the present disclosure may be a structure for combining a first sub trim (10) formed with a protrusion (11) and a second sub trim (20) formed with an accommodating groove (21) accommodating the protrusion (11) of the first sub trim (10). Here, a distal end of the protrusion (11) inserted in the accommodating groove (21) may be cooled after being melted, such that the first sub trim (10) and the second sub trim (20) can be permanently combined with each other.

Therefore, as illustrated in FIG. 2, the vehicle door trim coupling device may include a heat supplier (30) configured to melt the protrusion (11) and a molding part (50) configured to mold the protrusion (11) melted by the heat supplier (30).

The heat supplier (30) may include a body (31) and a heater (32) configured to heat a lateral circumferential part of the protrusion (11) by being disposed inside of a lower part of the body (31).

If the protrusion (11) is in a cylindrical shape, the body (31) may be in a cylindrical shape same as that of the protrusion (11). A heating hole (33) accommodating a part of the protrusion (11) may be formed at a lower end of the body (31) in which the heater (32) is disposed. The heater (32) may be disposed in the heating hole (33).

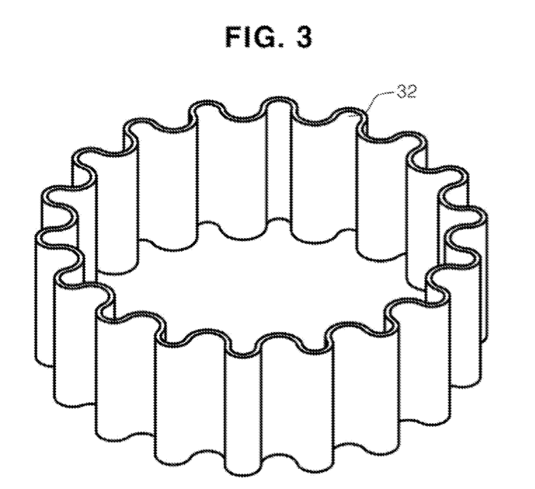

The heater (32) may be formed as a heating element radiating radiant heat by external power source. As illustrated in FIG. 3, the heating element may take a shape of a continuously curved flat plate, such that the expanded amount can he accommodated even when length of the heating element is expanded by heating.

Meanwhile, the heating hole (33) may be disposed to accommodate a part of the protrusion (11), in order for the heat supplier (30) to melt the protrusion (11),

Here, the heater (32) may be disposed being spaced apart from a circumferential surface of the protrusion (11) at a predetermined distance, such that the circumferential suffice of the protrusion may receive most of the radiant heat emitted from the heater (32). Thereby, the protrusion (11) can be melted in rapid time, which is an advantageous effect of the present disclosure.

In general, the melting temperature of thermoplastic resin used iii a vehicle interior material is around 165° C. Therefore, the temperature of the heater (32) may be 200° C. ˜800° C.,

Meanwhile, if the temperature of the heater (32) is under 200° C., the melting speed of the protrusion (11) becomes slower, which is disadvantageous for using in the industry. If the temperature of the heater (32) is exceeding 800° C., the transfer coefficient of radiant heat becomes lower in comparison to the temperature increase, which is also disadvantageous.

Alternatively, the temperature of the heater (32) may be 500° C. ˜800° C. The radiant heat transfer coefficient of the thermoplastic resin may be maximized in the above temperature range, such that the thermoplastic resin can become the most efficient.

Meanwhile, a separation distance between a distal end (when it is curved, a curved distal end) of the heater (32) and the protrusion (11) may be in a range of 0.1 mm ˜5 mm.

If the separation distance is under 0.1 mm, there is a risk in that some of the melted resin may contact the heater (32). If the separation distance is exceeding 5 mm, it is somewhat disadvantageous in an aspect of radiant heat transfer from the heater (32) to the protrusion (11).

Meanwhile, the molding part (50) may include a rod (51) and a contracting part attached on a distal end of the rod (51). The molding part (50) may be configured, to mold the protrusion (11) by pressurizing an upper end of the protrusion (11) melted by the heat supplier (30).

A lower end of the contacting part (52) may be so formed as to include a molded shape of the melted protrusion (11). The entire molding part (50) may pressurize the melted protrusion (11) to complete conjunction of the protrusion (11) and the accommodating hole (21).

As occasion demands, a plurality of air holes (54) may be formed at the molding part (50), such that pneumatic air may be sprayed through the air hole (54) after pressurization. Thereby, the elevated temperature of the molding part (50) may be decreased.

Here, the air hole (54) may be formed at the contacting part (52). Alternatively, the air hole (54) may be formed at the rod (51) such that the pneumatic air may cool at first the contacting part (52). In addition, the air hole (54) may be formed at both of the rod (51) and the contacting part (52).

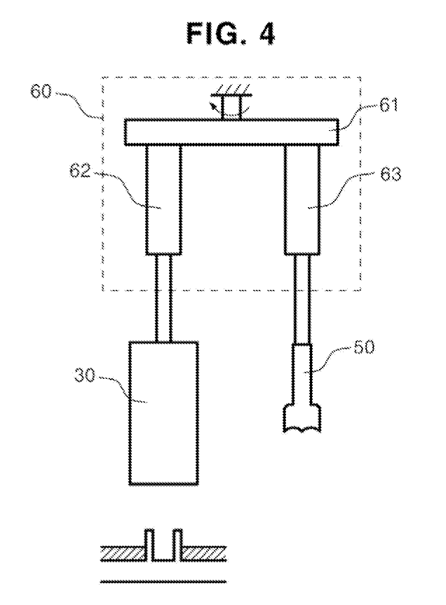

The vehicle door trim coupling device according to an exemplary embodiment of the present disclosure has a structure wherein the heat supplier (30) melts at first the protrusion (11) and the molding part (50) completes conjunction by pressurizing the melted protrusion (11). Therefore, as illustrated in FIG. 4, the vehicle door trim coupling device according, to an exemplary embodiment of the present disclosure may comprise a driving device (60) including a rotating base (61) disposed at an upper portion, a heating actuator (62) mounted to the rotating base (61) and configured to transfer the heat supplier (30) upward and downward, and a molding actuator (63) mounted near to the heating actuator (62) and configured to transfer the molding part (50) upward and downward.

In the structure described in the above, the first sub trim (10) and the second sub trim (20) may he coupled with each other by the following process.

At first, the rotating base (61) may be so driven as to dispose the heat supplier (30) at an upper end of the protrusion (11). Then, the heating actuator (62) may be transferred downward to instantaneously heat and melt the protrusion (11).

Afterwards, the heating, actuator (62) may be transferred upwards, and the rotating base (61) may be so driven as to dispose the molding part (50) at an upper end of the protrusion (11). Then, the molding actuator (63) may be transferred downward to mold the melted protrusion (11). Thereby, the conjunction between the protrusion (11) and the accommodating hole (21) may he completed.

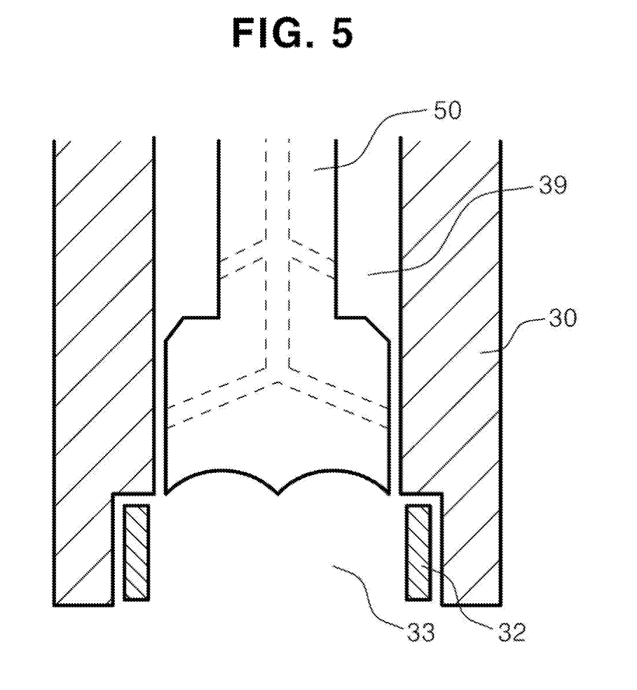

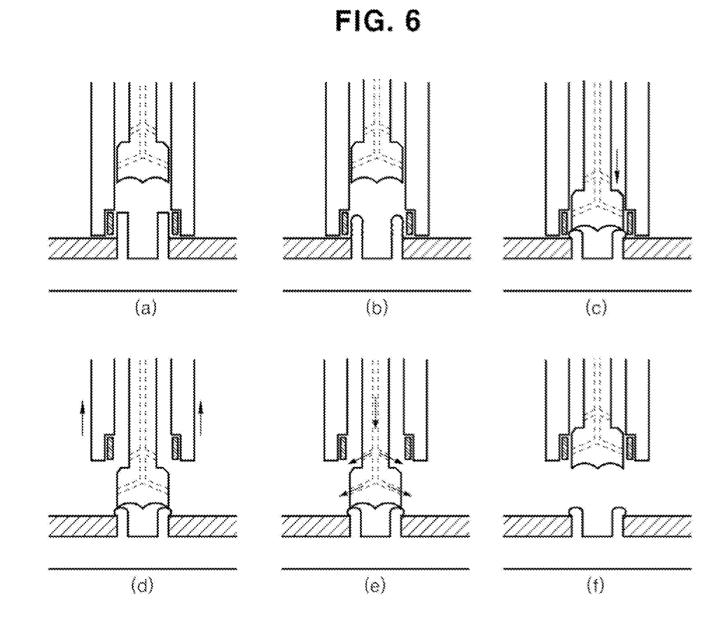

Meanwhile, according to an alternative exemplary embodiment of the present disclosure as illustrated in FIG. 5, a penetrating hole (39) may be formed in a center of a body (31) of the beat supplier (30), and the molding pan (50) may be disposed in the penetrating hole (39). In this case, there is an advantage in that the entire device may be implemented such that the molding can be performed immediately after melting of the protrusion (11) is finished.

Furthermore, the vehicle door trim coupling device may be implemented by using only the heating actuator (62) and the molding actuator (63), without requiring a separate rotating base (61). Therefore, the device can be implemented in a simpler configuration.

The configuration as described in the above may be driven in the following process.

As illustrated in FIG. 6, at first, the heating actuator (62) may be so driven as to dispose the heat supplier (30) at the protrusion (11) to be molded.

Afterwards, the heat supplier (32) may be applied with electric power to melt the protrusion (11).

When melting of the protrusion (11) is completed, the molding actuator (63) may be transferred downward to press-mold the melted part of the protrusion (11).

Then, the heating actuator (62) may be transferred upward.

Afterwards, air may be spayed through the air hole (54) to cool the molding part (50).

Then, the molding, actuator (63) may be driven to transfer the molding part (50) upward. Thereby, the conjunction may be completed.

Meanwhile, as occasion demands, the heating actuator (62) may be transferred downward such that the heat supplier (30) may melt the protrusion (11), the heat supplier (30) may be transferred upward, and then the molding actuator (63) may immediately transferred downward.

In addition, the air of the air hole (54) may be discharged simultaneously when the molding actuator (63) is being transferred downward.

Although some exemplary embodiments of the present disclosure have been described in the above, however, the present disclosure is not limited by the exemplary embodiments described above, but includes all kinds of various embodiments that would possibly be implemented within the scope of the claimed technical spirit of the present disclosure by a person having ordinary skill in the art to which the present disclosure pertains.

1. A vehicle door trim coupling device for combining a first sub trim made of a thermoplastic resin material formed with a protrusion and a second sub trim made of a thermoplastic resin material formed with an accommodating groove for accommodating the protrusion of the first sub trim, the vehicle door trim coupling device comprising:
a heat supplier configured to melt a part of the protrusion by radiant heat; and
a molding pan configured to press-mold the melted protrusion.

2. The vehicle door trim coupling device of claim 1, wherein the heat supplier includes:
a body;
a heating hole formed at a lower end of the body and accommodating a pan of the protrusion; and
a heater formed spaced apart from a circumferential surface of the protrusion at a predetermined distance by being disposed inside of the heating hole, and configured to emit radiant heat.

3. The vehicle door trim coupling device of claim 2, wherein a temperature of the heater is 200°C. ˜800° C.

4. The vehicle door trim coupling device of claim 3, wherein a temperature of the heater is 500° C. ˜800° C.

5. The vehicle door trim coupling, device of claim 3, wherein the heater takes a shape of a continuously curved flat plate.

6. The vehicle door trim coupling device of claim 1, wherein the molding part includes:
a rod; and
a contracting part attached on a distal end of the rod and configured to pressurize the melted protrusion.

7. The vehicle door trim coupling device of claim 6, wherein an air hole is formed at the rod such that pneumatic air is discharged through the air hole after molding is finished.

8. The vehicle door trim coupling, device of claim 6, wherein an air hole is formed at the contacting pan such that pneumatic air is discharged through the air hole after molding is finished.

9. The vehicle door trim coupling device of claim 5, wherein the body further includes, in an internal center thereof, a penetrating, hole in a longitudinal direction, and
the molding part is disposed in the penetrating hole to move in a longitudinal direction of the penetrating hole.

10. The vehicle door trim coupling, device of claim 9, wherein after the protrusion is melted by the beat supplier, the molding part disposed in the penetrating hole moves downward to pressurize and mold the melted protrusion.
